(19) United States
(12) Patent Application Publication
(10) Pub. No.: US 2024/0397418 A1
(43) Pub. Date: Nov. 28, 2024

(54) NETWORK SLICE ADMISSION CONTROL AND TERMINAL MOBILITY

(71) Applicant: Lenovo (Singapore) Pte. Ltd., New Tech Park (SG)

(72) Inventor: Genadi Velev, Darmstadt (DE)

(21) Appl. No.: 18/700,661

(22) PCT Filed: Oct. 11, 2022
(86) PCT No.: PCT/IB2022/059747

§ 371 Date: Apr. 11, 2024

Related U.S. Application Data
(60) Provisional application No. 63/254,396, filed on Oct. 11, 2021.

(51) Int. Cl. H04W 48/18; H04W 48/02

(52) U.S. Cl. CPC H04W 48/18; H04W 48/02

(57) ABSTRACT

Apparatuses, methods, and systems are disclosed for network slice admission control and terminal mobility. One embodiment of a method includes, from a user equipment (UE) (102), receiving a first message requesting to register with a network slice. The method also includes determining a network slice update type parameter, a service type parameter, or both, based on UE registration in the first message or subscription data. The method further includes transmitting, to a network slice admission control function entity (NSACF) (416, 418), a second message requesting to modify a number of UEs registered with the network slice, wherein the second message includes the network slice update type parameter, the service type parameter, or the combination thereof.

### CROSS-REFERENCE TO RELATED APPLICATIONS

This application claims priority to U.S. Patent Application Ser. No. 63/254,396 entitled “APPARATUSES, METHODS, AND SYSTEMS FOR NETWORK SLICE ADMISSION CONTROL AND TERMINAL MOBILITY” and filed on Oct. 11, 2021 for Genadi Velev, which is incorporated herein by reference in its entirety.

### FIELD

The subject matter disclosed herein relates generally to wireless communications and more particularly relates to apparatuses, method, and systems for network slice admission control and terminal mobility.

### BACKGROUND

In certain wireless communications networks, network slices may be used.

### BRIEF SUMMARY

Methods for performing network slice admission control are disclosed. Apparatuses and systems also perform the functions of the methods. One embodiment of a method includes receiving, from a user equipment (“UE”), a first message requesting to register with a network slice. The method also includes determining a network slice update type parameter, a service type parameter, or both, based on UE registration data in the first message or subscription data and transmitting, to a network slice admission control function entity (“NSACF”), a second message requesting to modify a number of UEs registered with the network slice, the second message comprising the network slice update type parameter, or the service type parameter, or both.

One embodiment of an apparatus for wireless communication includes a processor and a memory coupled with the processor. The processor is configured to cause the apparatus to receive, from a user equipment (“UE”), a first message requesting to register with a network slice, determine a network slice update type parameter, a service type parameter, or both based on UE registration data in the first message or subscription data, and transmit, to a network slice admission control function entity (“NSACF”), a second message requesting to modify the number of UEs registered with the network slice, the second message comprising the network slice update type parameter, the service type, or both.

Another embodiment of a method at an NSACF entity includes receiving from a network function entity (“NF”) a request message indicating modify of a number of UEs registered with a network slice, the request message includes a slice update type parameter for the network slice, a service type parameter, or a combination thereof, determining whether to accept or reject registration of the network slice based on a current number of UEs registered with the network slice having reached a maximum number of UEs and the network slice update type parameter, the service type parameter, or both, and transmitting a response message indicating acceptance or rejection of the network slice registration.

Another embodiment of an apparatus includes a processor and a memory coupled with the processor. The processor is configured to cause the apparatus to: receive, from a network function entity (“NF”), a request message indicating to modify a number of user equipments (“UEs”) registered with a network slice, wherein the request message includes a slice update type parameter for the network slice, a service type parameter, or both: determine whether to accept or a reject registration of the network slice based on the number of UEs registered with the network slice satisfying a threshold number of UEs and the network slice update type parameter, the service type parameter, or both; and transmitting a response message indicating an acceptance or a rejection of the network slice registration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for network slice admission control and terminal mobility;

FIG. 2 is a schematic block diagram illustrating one embodiment of an apparatus that may be used for network slice admission control and terminal mobility:

FIG. 3 is a schematic block diagram illustrating another embodiment of an apparatus that may be used for network slice admission control and terminal mobility:

FIG. 4 is a communications system control diagram:

FIG. 5 is a process diagram performed by components shown in the diagram of FIG. 4:

FIG. 6 is a process diagram performed by components shown in the diagram of FIG. 4:

FIG. 7 is a flowchart of a process for network slice admission control and terminal mobility; and

FIG. 8 is a flowchart of a process for network slice admission control and terminal mobility.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

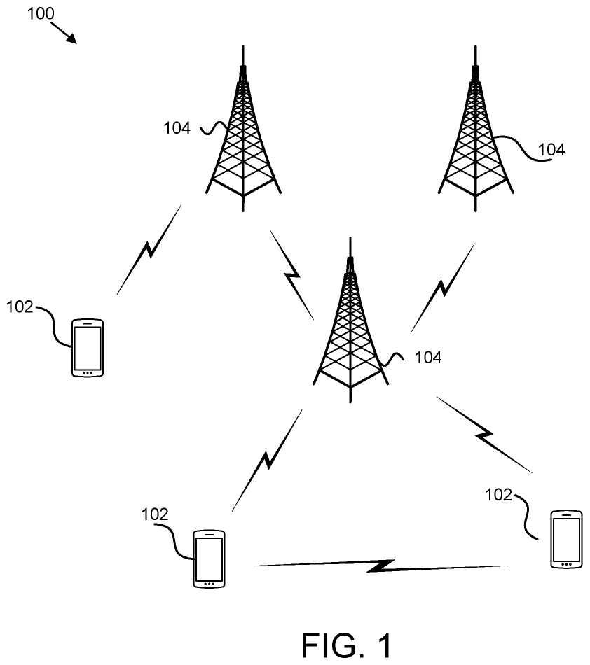

FIG. 1 depicts an embodiment of a wireless communication system 100 for network slice admission control and terminal mobility. In one embodiment, the wireless communication system 100 includes remote units (user equipment (“UE”)) 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals.

The network units or network function entity (“NF”) 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 3GPP protocol, wherein the network unit 104 transmits using an orthogonal frequency division multiplex (“OFDM”) modulation scheme on the download (“DL”) and the remote units 102 transmit on the UL using a single carrier-frequency division multiple access (“SC-FDMA”) scheme or an OFDM scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In one embodiment, a NF 104 receives a first message from a UE 102 requesting to register with a network slice. Then, the NF 104 determines a network slice update type parameter, or a service type parameter, or a combination thereof responsive to UE registration or subscription data in the first message or existing network slice information and sends a second message to a NSACF requesting to increase a number of UEs registered with the network slice. The second message includes the network slice update type parameter, or the service type parameter, or the combination thereof.

In certain embodiments, a second NF 104 receives from a first NF a request message indicating increase of a number of UEs 102 registered with a network slice, the request message includes a slice update type parameter for the network slice, a service type parameter, or a combination thereof, determines whether to accept or reject registration of the network slice based on a current number of UEs registered with the network slice having reached a maximum number of UEs and the network slice update type parameter or the service type parameter, and send a response message indicating acceptance or rejection of the network slice registration responsive to determining whether to accept or to reject the registration of the network slice for a UE 102 associated with the received message.

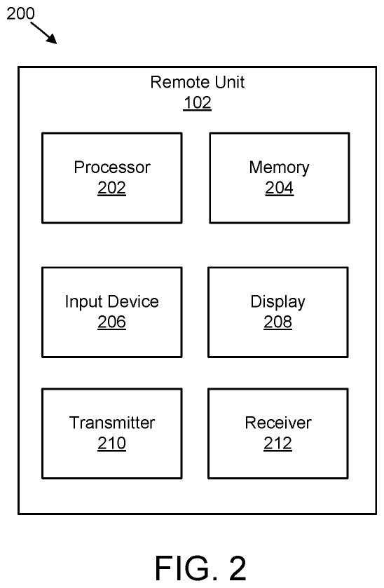

FIG. 2 depicts one embodiment of an apparatus 200 that may be used for network slice admission control and terminal mobility. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the network unit 104 and the receiver 212 is used to receive DL communication signals from the network unit 104, as described herein. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

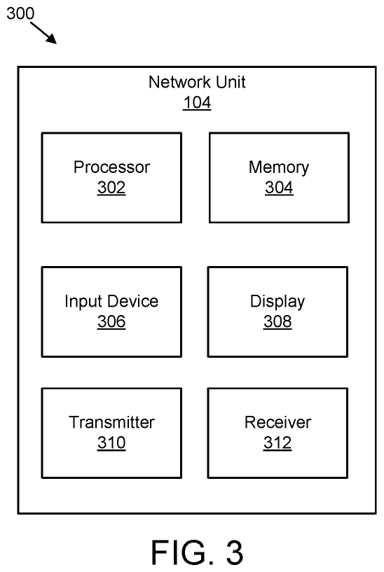

FIG. 3 depicts one embodiment of an apparatus 300 that may be used for network slice admission control and terminal mobility. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

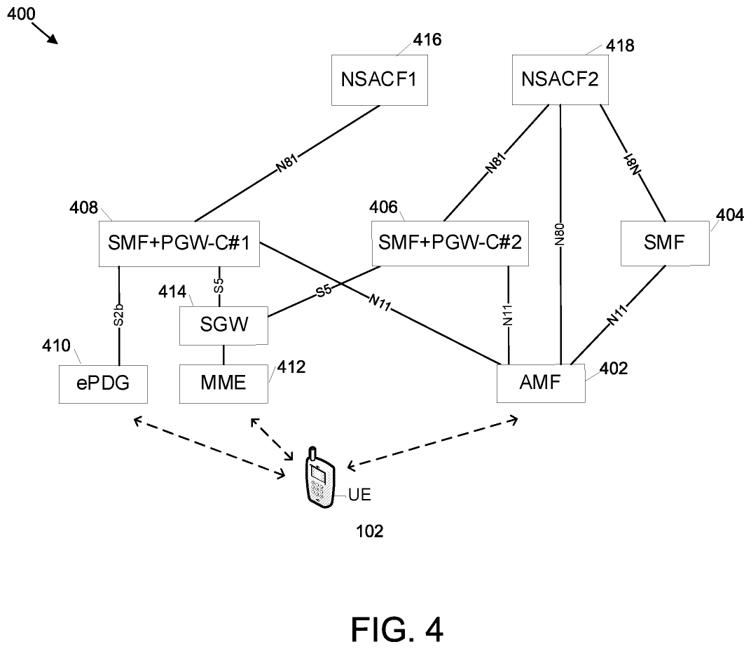

Referring to FIG. 4, an exemplary network topology/architecture 400 includes an evolved packet core (“EPC” or “EPS”) network 420, e.g., or a 5^{th} generation core network (“5GC” or “5GS”) 422. The EPC 420 uses a mobility management entity (“MME”) 412 (for 3^{rd} generation partnership project (“3GPP”) access) or an evolved packet data gateway (“ePDG”) 410 (for untrusted non-3GPP access). The 5GC 422 uses an access and mobility management function (“AMF”) 402 (for both 3GPP access and non-3GPP access). A network function (session management function (“SMF”)+packet data network (“PDN”) gateway control function (“PGW-C”) 406, 408) provides interworking between the 5GS 422 and the EPC 420 and may implement the functionality of the SMF 404 of the 5GC 422 and the functionality of the control plane entity of the PDN Gateway (called PGW-C). A serving gateway (“SGW”) 414 connects with the SMF+PGW-C 406, 408 via an S5 interface, specifically via an S5-C interface. The AMF 402 connects with the SMF+PGW-C 406, 408 (used for data sessions for which interworking between the EPS 420 and the 5GS 422 is required) via an N11 interface and with an SMF 404 (used for the 5GS 422 only data sessions, i.e. protocol data unit (“PDU”) sessions) via the same N11 interface. For the purpose of network slice admission control (“NSAC”) for maximum number of UEs (“MaxNrUEs”) and/or maximum number of PDU sessions (“MaxNrsessions”), an N81 interface, originally intended to connect the SMF 404 and the NSACF 416, 418, is used to connect the SMF+PGW-C 406, 408 and the NSACF 416, 418 and an N80 interface between the AMF 402 and the NSACF 416, 418. The N80 interface offers services for NSAC for MaxNrUEs.

It is assumed that the UE 102 may register with the 5GS 422 via the AMF 402 (e.g., using 3GPP or Non-3GPP access) and with the EPS 420 via the MME 412, the ePDG 410, or via trusted Non-3GPP access (not shown). The UE 102 is allowed to use one or more network slices (e.g., identified by single network slice selection assistance information (“S-NSSAI #1”, “S-NSSAI #2”, etc.). Some of the network slices may be subject to NSAC, e.g., both S-NSSAI #1 and S-NSSAI #2 may be subject to NSAC.

The SMF+PGW-C 406, 408 performs the NSAC procedure for MaxNrUEs and the NSAC procedure for MaxNrsessions, when the UE 102 is attached to the EPS 420. When the UE 102 is registered in the 5GS 422, the AMF 402 performs the NSAC procedure for MaxNrUEs and the SMF 404 performs the NSAC procedure for MaxNrsessions.

According to the newest standard developments, each network function (“NF”) responsible for updating the NSACF 416, 418 (e.g., the AMF 402, or the SMF+PGW-C 406, 408) can send update request to the NSACF 416, 418 to increase or decrease the number of UEs when a UE registers or deregisters including the NF identifier (“ID”) (in case of the AMF 402) or when a PDN connection is established or released in the EPC 420 (e.g., in case of the SMF+PGW-C 406, 408). With this, the NSACF 416, 418 may store multiple entries for the same UE 102 (e.g., based on the UE-ID) where the entries are differentiated by different sourcing NFs (e.g., AMF ID or the SMF+PGW-C ID) which has sent the update request to the NSACF 416, 418. The NSACF 416, 418 counts the UE 102 only once for the same access type (“AT”) or according to internal policies in the NSACF 416, 418.

The NSACF 416, 418 may store UE ID with the associated access type, i.e. there may be multiple entries in the NSACF 416, 418 associated with the same UE ID but different AT. The NSACF 416, 418 takes AT into account for increasing and decreasing the number of UEs using the S-NSSAI subject to NSAC.

In various embodiments, the SMF+PGW-C#1 408 may be connected to the NSACF1 416 whereas the SMF+PGW-C#2 406, the AMF 402, and the SMF 404 may be connected to the NSACF2 418. The maximum number of UEs 203 or PDU sessions for the S-NSSAI may be split in 2 portions and each portion is configured in the NSACF1 416 and the NSACF2 418. It is possible that NSACF1 416 and the NSACF2 418 are coordinated and the portions are changed dynamically either via a direct interface between the NSACF1 416 and the NSACF2 418 or via the operations, administration and management (“OAM”) system.

If the UE 102 moves between different AMFs or between the AMF 402 and the SMF+PGW-C 406, 408, where the source and target NF send updates to the different NSACF, and the maximum number of UEs has been reached in the new/target NSACFs, the new/target NSACF may reject the update request, even though the UE 102 has already been registered with the S-NSSAI. With this, the service used by the UE 102 is dropped which results in bad user/service experience.

In another scenario, when the UE uses a high priority service (e.g., mission critical services (“MCS”), or multimedia priority services (“MPS”)), it is assumed that the network should not apply NSAC. Currently, if the updating NF (e.g., the AMF 402 or the SMF+PGW-C 406, 408) omits sending the update request to the NSACF 416, 418, the NSACF 416, 418 will not have the correct number of UEs (or PDU sessions). Therefore, another problem is how to differentiate the importance of service in the network to avoid rejection of the service and allow the counting of the UEs (or PDU sessions) in the NSACF 416, 418.

The AMF 402 may send an access type parameter to the NSACF 416, 418. However, there is no description of how the combined node the SMF+PGW-C 406, 408 sends an access type parameter to the NSACF 416, 418.

In various embodiments, upon receiving a request to register to an S-NSSAI subject to NSAC, the AMF 402 (or the SMF+PGW-C 406, 408) determines a network slice update type parameter for the S-NSSAI to be sent to the NSACF 416, 418. The network slice update type parameter for the S-NSSAI may have a new value (in case the S-NSSAI is not part of the existing allowed NSSAI) or an existing value (in case the S-NSSAI is part of the existing allowed NSSAI). In addition, the AMF 402 (or the SMF+PGW-C 406, 408) may determine to include a service type parameter (which triggers the registration to the S-NSSAI) in the request to the NSACF 416, 418. The service type parameter may be voice, MCS, MPS, or the like.

In various embodiments, the AMF 402 sends to the NSACF 416, 418 the network slice update type parameter (type of update request for the S-NSSAI), the service type parameter, or a combination thereof.

In various embodiments, the NSACF 416, 418 accepts the update request including the network slice update type parameter with the existing value even if the max. number of UEs is reached and the UE-ID is not on a list of registered UEs. Otherwise, if the update request includes network slice update type parameter with the new value, the NSACF 416, 418 rejects the update request.

In various embodiments, the NSACF 416, 418 accepts the update request including the service type parameter being emergency, MCS, or MPS even if the max. number of UEs is reached and the UE-ID is not in the list of registered UEs.

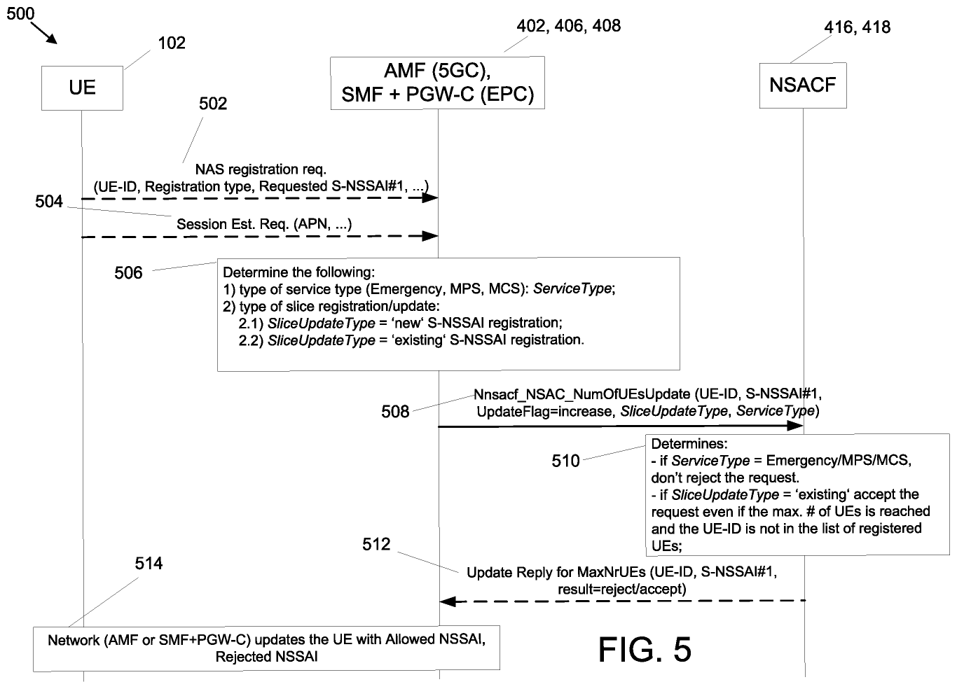

Referring to FIG. 5, in various embodiments, a procedure for NSAC for the maximum number of UEs (“MaxNrUEs”) where the NSAC is considered the AT or a core network type (“CNT”) used currently by the UE is shown. In other words, the network (i.e. the NSACF 416, 418) applies differentiated counting of UEs or sessions using a particular AT or particular CNT.

At either step 502 or 504, the UE 102 requests registration to the 5GS 422 or a data connection establishment in the EPS 420 using the NAS protocol. At the step 502, the UE sends a registration request message to the AMF 402 in the 5GS 422. The message may include at least the UE identifier (“UE ID”), the requested NSSAI including one or more the network slice IDs (S-NSSAIs) to which the UE wants to be registered. The AMF determines which AT is the UE 102 using (e.g., the AT is 3GPP or non 3GPP). At the step 504, the UE 102 sends a session establishment request message, e.g., PDN connectivity request message to the SMF+PGW-C 406, 408 in the EPS. The message may include at least an Access Point Name (“APN”), to which the UE 102 wants to establish the data connection (e.g., PDN Connection). At a step 506, the AMF 402 or the SMF+PGW-C 406, 408 determines to trigger the NSAC procedure for the MaxNrUEs based on the configuration that a requested S-NSSAI is subject to NSAC (e.g., based on local configuration or by OAM system). When the type of UE registration indicates emergency, or UE subscription data indicates that the UE 102 is allowed to use a priority service (e.g., MPS or MCS) over a particular slice, the AMF 402 or the SMF+PGW-C 406, 408 decides to include the service type parameter in the update request to the NSACF 416, 418 to increase the number of UEs.

Alternatively or additionally, the AMF 402 or the SMF+PGW-C 406, 408 includes the network slice update type parameter. The network slice update type parameter can have at least one of the following slice update types is new when the S-NSSAI has not been part of the old/existing allowed NSSAI. In other words, when the S-NSSAI is intended to be included in the allowed NSSAI, but without being part of the previous allowed NSSAI. For example, the AMF 402 may determine this parameter value by comparing whether the S-NSSAI, for which an update is to be sent to the NSACF 416, 418, is part of the previous (or current) list of allowed NSSAIs. One alternative value can be called ‘initial’ slice update. The network slice update type parameter is existing when the S-NSSAI is part of the old/existing allowed NSSAI. For example, the AMF 402 may determine this parameter value by comparing whether the S-NSSAI, for which an update is to be sent to the NSACF 416, 418, is part of the previous (or current) list of allowed NSSAIs. If the S-NSSAI is already in the previous (or current) allowed NSSAI, then the AMF 402 determines that the value is existing (or slice update due to ‘mobility’).

At a step 508, the AMF 402 or the SMF+PGW-C 406, 408 send an update request to the NSACF 416, 418 to increase the number of UEs. The AMF or the SMF+PGW-C 406, 408 may include, in addition to the existing parameters, the slice update type parameter, the service type parameter, or a combination thereof. For example, the following service operation can be used:
Nnsacf_NSAC_NumOfUEsUpdate (UE-ID. S-NSSAI #1, UpdateFlag=increase. SliceUpdate Type, UEregType, Service Type).

At step 510, the NSACF 416, 418 receives the update request message and checks internally the availability of the S-NSSAI and whether the UE for this UE-ID is already registered with the S-NSSAI. The NSACF 416, 418 determines to apply one of the following processes:
if the service type parameter is included and the value is equal to at least one of emergency. MPS or MCS, the NSACF 416, 418 does not reject the request received from the AMF 402 or SMF+PGW-C. In other words, the NSACF 416, 418 exempts the NSAC procedure for such UEs. The NSACF 416, 418 may store the indication of service type in the UE entry. The NSACF 416, 418 may count the UEs with the service type (emergency, MCS, or MPS) in one of the following ways: a) together with the UEs registered without [Emergency. MPS or MCS] indication, or b) in a separate counter for UE to which exemption applied. In anyway, the NSACF 416, 418 may maintain the current number of UEs using non-priority service (i.e. number of UEs for which NSAC is applied) and a current number of UEs using priority service (e.g., the UEs for which NSAC exemption applies);
if the slice update type parameter is existing, the NSACF 416, 418 accepts the request even if the max. # of UEs is reached and the UE-ID is not in the list of registered UEs. The slice update type parameter equal to existing has the meaning to NSACF 416, 418 that the UE is already registered with the S-NSSAI (e.g., S-NSSAI #1) and the UE has been already counted. Therefore, by accepting the UE, total number of actually registered UEs would not be increased because the UE 102 would be de-registered from another AMF or SMF+PGW-C in possibly another NSACF; or
if slice update type parameter is new, the max. # of UEs is reached and the UE-ID is not in the list of registered UEs, the NSACF 416, 418 rejects the request.

At a step 512, the NSACF 416, 418 responds to the AMF 402 or the SMF+PGW-C 406, 408 with result information of whether the network slice is available or not available (i.e. rejected). For example, the NSACF 416, 418 sends update reply message for MaxNrUEs, whereas the message includes at least the following parameters: UE-ID. S-NSSAI #1, result, or the like.

At a step 514, the AMF 402 or the SMF+PGW-C 406, 408 proceeds further with registration or UCU procedure. The AMF or the SMF+PGW-C 406, 408 determine the allowed NSSAI, rejected NSSAI, target NSSAI based on the result from the NSACF 416, 418 received in step 512.

The NSACF 416, 418 may offer service exposure to another NFs or application functions (Afs) for different categories of number of UEs (or PDU sessions): current number of UEs using non-priority service (i.e., number of UEs for which NSAC is applied); and a current number of UEs using priority service (e.g., the UEs for which NSAC exemption applies).

The process 500 of FIG. 5 can be also applied for the scenario of NSAC for the MaxNrsessions. For this purpose, the SMF 404 (or SMF+PGW-C) may include the session update type parameter, which is similar to the slice update type parameter described in step 506 (e.g., can have the similar values of new and existing), in the request to the NSACF 416, 418 for increasing the number of PDU sessions. For example, the session update type parameter is included in the service operation Nnsacf_NSAC_NumOfPDUsUpdate_Request. The NSACF 416, 418 can decide whether to increase, decrease, or do not change the total number of PDU sessions based on the session update type parameter.

The SMF 404 or SMF+PGW-C may also use the service type parameter in the update for NSAC for maximum number of PDU sessions to the NSACF 416, 418. This may happen when the initial PDU Session has been established for non-priority service and afterwards a priority service is established. The NSACF 416, 418 may maintain separate counters for a number of PDU sessions for non-priority service and number of PDU sessions for priority services. The maximum number of PDU sessions is applied only to the PDU sessions for non-priority service. In other words, the number of PDU sessions for priority services are exempted for NSAC in the NSACF 416, 418.

In various embodiments, it is possible that during the registration to an S-NSSAI or establishing a PDU Session associated with an S-NSSAI subject to NSAC, the used service is emergency, MCS or MPS service. In such case, the AMF 402 or the SMF 404 (or SMF+PGW-C) may exempt the NSAC procedure, i.e., to omit the update request to the NSACF 416, 418 for the maximum number of UEs or maximum number of PDU sessions. However, if the emergency, MCS, or MPS session is terminated and the UE remains registered with the S-NSSAI (or the PDU Session is not released), the NSAC procedure may need to be performed. This determines how to trigger the NSAC procedure.

In various embodiments, for the MaxNrUEs, if the AMF 402 or SMF+PGW-C has exempted NSAC due to priority service (e.g., Emergency, MCS or MPS session) during the registration with the S-NSSAI and the AMF 402 or SMF+PGW-C determines that the priority service does not apply any longer, the AMF 402 or SMF+PGW-C sends to the NSACF 416, 418 an update request with an increase update flag. For example, the priority service (e.g., Emergency, MCS or MPS session) may be terminated when the corresponding bearer(s) (or QoS flows) or PDU sessions are terminated and only the default QoS profile for a PDU Session applies or the UE is registered with the S-NSSAI without established PDU Session.

In various embodiments, in the case of NSAC for the MaxNrsessions, if the SMF 404 or SMF+PGW-C has exempted NSAC due to priority service (e.g., emergency, MCS or MPS session) during the PDU Session establishment and the SMF 404 or SMF+PGW-C determines that the priority service does not apply any longer, the SMF 404 or SMF+PGW-C sends to the NSACF 416, 418 an update request with an increase update flag. For example, the priority service (e.g., emergency. MCS or MPS session) may be terminated when the corresponding bearer(s) (or QoS flows) are terminated and only the default QoS profile for a PDU Session applies.

In various embodiments, it also possible that the UE 102 has either registered to S-NSSAI subject to NSAC for maximum number of UEs or has established a PDU Session to an S-NSSAI subject to NSAC for maximum number of PDU sessions without using non-priority service (e.g., none of Emergency. MCS or MPS session). However, after some time a priority service starts over the S-NSSAI or PDU session. In such case, the NF triggering the NSAC procedure (e.g., AMF, the SMF 404 or SMF+PGW-C) may inform the NSACF 416, 418 for the change (i.e. for the establishment of priority service). In particular, the following applies:
In the case of NSAC for the MaxNrUEs, if the AMF 402 or SMF+PGW-C has sent update request to the NSACF 416, 418 to increase the number of UEs and a priority service (e.g., Emergency. MCS or MPS session) is established afterwards, the AMF 402 or SMF+PGW-C may update the NSACF 416, 418 that currently a priority service is used. For this purpose, the AMF 402 or SMF+PGW-C may use the service type parameter, as described in step 506 in FIG. 5. Based on this parameter, the NSACF 416, 418 may keep the entry for the UE (and also associated with the AMF ID or SMF+PGW-C ID), but the NSACF 416, 418 may reduce the current number of UEs registered with the network slice for non-priority service. In addition, the NSACF 416, 418 may increase the number of UEs using the priority service (i.e. for which NSAC exemption is applied).
In case of NSAC for the MaxNrsessions, if the SMF 404 or SMF+PGW-C has sent update request to the NSACF 416, 418 to increase the number of PDU sessions and a priority service (e.g., Emergency, MCS or MPS session) is established afterwards, the SMF 404 or the SMF+PGW-C 406, 408 may update the NSACF 416, 418 that currently a priority service is used. For this purpose, the SMF 404 or the SMF+PGW-C 406, 408 may use the service type parameter, as described in step 506 in FIG. 5. Based on this parameter, the NSACF 416, 418 may keep the entry for the UE (and also associated with the SMF ID or SMF+PGW-C ID), but the NSACF 416, 418 may reduce the current number of PDU sessions registered with the network slice for non-priority service. In addition, the NSACF 416, 418 may increase the number of PDU sessions using the priority service (i.e. for which NSAC exemption is applied).

In various embodiments, it is assumed that the UE moves between EPC to 5GC, but also mobility among 5GC only and mobility among EPC only. Currently when the UE with ongoing PDN connection(s) moves from EPC to 5GC, the SMF+PGW-C 406, 408 triggers a request to decrease the number of the UE registered in the NSACF 416, 418 and the AMF 402 triggers a request to increase the number of the UE registered in the NSACF 416, 418 when the UE is registered in the new AMF. Also, when the UE with ongoing PDU session(s) moves from 5GC to EPC, the SMF+PGW-C 406, 408 triggers a request to increase the number of the UE registered in the NSACF 416, 418 and the old AMF triggers a request to decrease the number of the UE registered in the NSACF 416, 418 when the UE is deregistered in old AMF.

In the above two procedures a race-conditions at the NSACF 416, 418 might happen. In one example, the SMF+PGW-C 406, 408 first decreases the number of UEs and when the AMF 402 wants to increase the number and the maximum number of UEs is already reached, then the NSACF 416, 418 rejects the request to the AMF 402. In another example, the AMF 402 first decreases the number of UEs and when the SMF+PGW-C 406, 408 wants to increase the number of UEs and the maximum number of UEs is already reached, then the NSACF 416, 418 rejects the request to the SMF+PGW-C 406, 408. The problem is that the session continuity is cannot be guaranteed.

In various embodiments, in mobility scenarios (e.g., mobility between different mobility management (“MM”) service network functions), the AMF 402 or the SMF+PGW-C 406, 408 may determine to delay the update to decrease the number of UEs for some configured time. In other words, the AMF 402 or the SMF+PGW-C 406, 408 determines to use the delay time when the UE is moving (in a connected state or an idle state) to another core network entity (e.g., from one [the AMF 402 or the SMF+PGW-C 406, 408] another [the AMF 402 or the SMF+PGW-C 406, 408]) whereas the other EPC or 5GC NF retrieves the UE context and the UE was registered at the NSACF 416, 418 for the S-NSSAI is subject to NSAC for maximum number of UEs. When the UE is deregistering from the network or the PDN connection is released, the AMF 402 or the SMF+PGW-C 406, 408 send to the NSACF 416, 418 the update to decrease the number of UEs without using the delay time. The delay time may be configured in the AMF 402 or the SMF+PGW-C 406, 408 by implementation or by the OAM system, or can use a standardized value (e.g., 500 millisecond or 5 seconds).

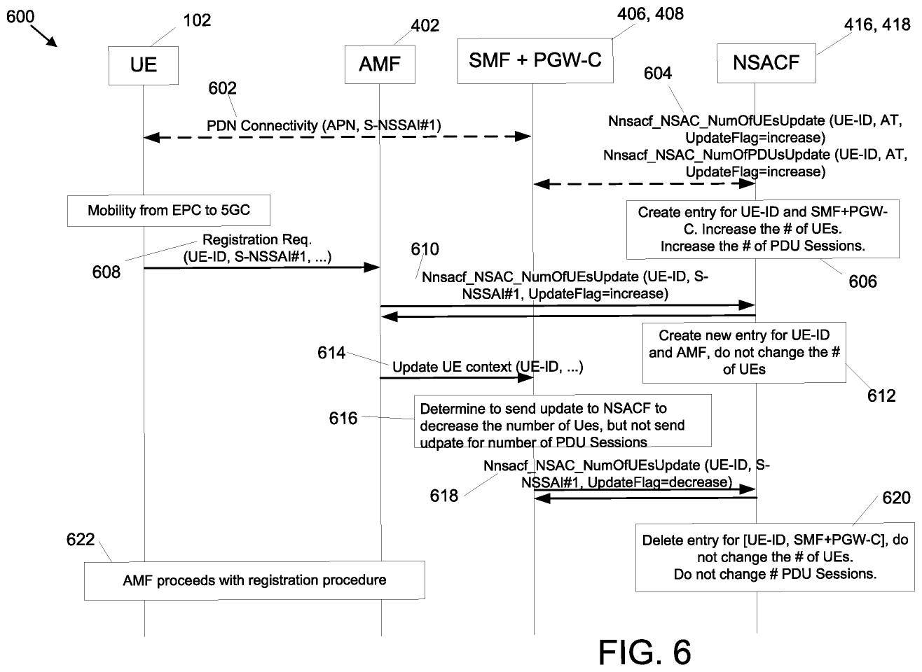

In various embodiments, because the UE currently moves between EPC to 5GC as described above, it is unclear what is the SMF+PGW-C 406, 408 behavior when NSAC for maximum number of PDU sessions apply. During NSAC for maximum number of PDU sessions when the UE moves between 5GC and EPC and PDU sessions are handed over, the SMF+PGW-C 406, 408 does not send an update to the NSACF 416, 418. Referring to FIG. 6, an NSAC procedure 600 for both maximum number of UEs and maximum number of PDU sessions during UE mobility from EPC to 5GC is performed. Similar procedure may be also applied in case of mobility from 5GC to EPC (not shown). At a step 602, the UE 102 is attached to EPS 420 and requests establishment of data connection/session that is sent to the SMF+PGW-C 406, 408 using the NAS protocol. The SMF+PGW-C 406, 408 determines that the PDN Connection is associated with S-NSSAI #1 which is subject to NSAC for maximum number of UEs and NSAC for maximum number of PDU sessions. At a step 604, the SMF+PGW-C 406, 408 sends update request to the NSACF 416, 418 to increase the number of UEs and an update request to increase the number of PDU sessions. At a step 606, the NSACF 416, 418 creates an entry in the list of registered UEs for the S-NSSAI #1 by using the UE-ID and SMF+PGW-C ID. The NSACF 416, 418 increases the number of UEs or the NSACF 416, 418 increases the number of PDU sessions. At a step 608, after some time the UE 102 performs a mobility from the EPC 420 to the 5GC 422 (which can be UE initiated or network initiated). The UE 102 performs a registration procedure towards the 5GC. The registration request message may include a request to register with a specific network slice (e.g., S-NSSAI #1). The AMF 402 would retrieve the UE context from the MME (if N26 interface is in place) or from the UDM (if N26 interface is not in place).

At a step 610, the AMF 402 determines that the S-NSSAI #1 is subject to NSAC for maximum number of UEs and sends an update request to the NSACF 416, 418 with an increase update flag set. The AMF 402 may use the service operation Nnsacf_NSAC_NumOfUEsUpdate request including at least one of the parameters UE-ID, S-NSSAI #1 and UpdateFlag-increase.

At a step 612, the NSACF 416, 418 creates a new entry (or updates the existing entry) in the list of registered UEs for the S-NSSAI #1 by using the same UE-ID as in step 606, but a different NF IF, i.e. AMF ID. The NSACF 416, 418 does not increase the number of UEs.

At a step 614, the AMF 402 updates the UE context in the SMF+PGW-C 406, 408 to establish signaling association between the AMF 402 and the SMF+PGW-C 406, 408 (e.g., over the N11 interface). The AMF 402 indicates that the existing PDN connection is transferred (i.e. handed over) to the 5GC which means the SMF+PGW-C 406, 408 keeps the SM context for the PDN connection (or PDU session).

At a step 616, the SMF+PGW-C 406, 408 determines that the UE 102 has moved from the EPC 420 to the 5GC 422 and that the PDU session is handed over. The SMF+PGW-C 406, 408 determines that it needs to update the NSACF 416, 418 and deregister the UE 102 in the NSACF 416, 418. The SMF+PGW-C 406, 408 sends an update to the NSACF 416, 418 to decrease the number of UEs. However, the SMF+PGW-C 406, 408 determines to not send update request for NSAC for number of PDU sessions, because the same PDN connection from EPC is handed over to 5GC.

At a step 618, the SMF+PGW-C 406, 408 sends to the NSACF 416, 418 an update request for NSAC for number of UEs with a flag to decrease the number. For example, the SMF+PGW-C 406, 408 may use the service operation Nnsacf_NSAC_NumOfUEsUpdate including the parameters UE-ID, S-NSSAI #1 and UpdateFlag=decrease.

At a step 620, the NSACF 416, 418 deletes the entry for UE-ID and the SMF+PGW-C 406, 408 and the NSACF 416, 418 does not change the number of UEs (because there is another entry for the UE ID from the AMF 402 which remains in the NSACF 416, 418). The NSACF 416, 418 also doesn't change the number of PDU sessions.

At a step 622, the AMF 402 proceeds with the other steps of the registration procedure, e.g., sending registration accept message to the UE.

Signalling from the SMF+PGW-C 406, 408 to the NSACF 416, 418 is omitted in the case of NSAC for maximum number of PDU sessions and mobility between EPC and 5GC when the PDU sessions or PDN connections are handed over. Same or similar mechanism can be applied in the case of mobility from 5GC to EPC. In such case, the SMF+PGW-C 406, 408 determines to not send update request to the NSACF 416, 418 for NSAC for maximum number of PDU sessions because the PDU Session from 5GC is handed over to PDN Connection in EPC (and no need to update the NSACF 416, 418 as the same sessions continues to be used). However, the SMF+PGW-C 406, 408 sends an update request to the NSACF 416, 418 for NSAC for maximum number of UEs to increase the number of UEs.

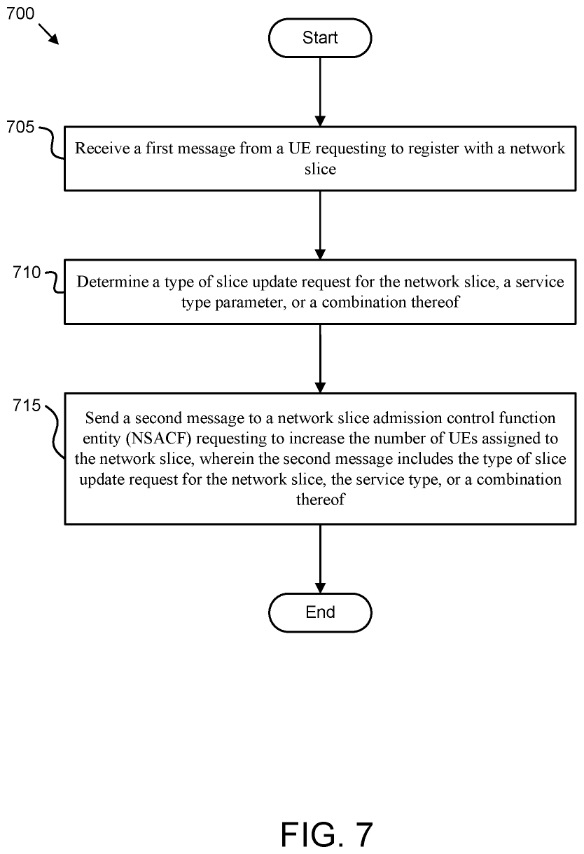

Referring to FIG. 7, a flow diagram of a method 700 performed at a NF entity. At a block 705, a first message is received from a UE requesting to register with a network slice. At a block 710, a type of slice update request for the network slice, a service type parameter, or a combination thereof is determined. At a block 715, a second message is sent to a NSACF requesting to increase the number of UEs assigned to the network slice, wherein the second message includes the type of slice update request for the network slice, the service type, or a combination thereof.

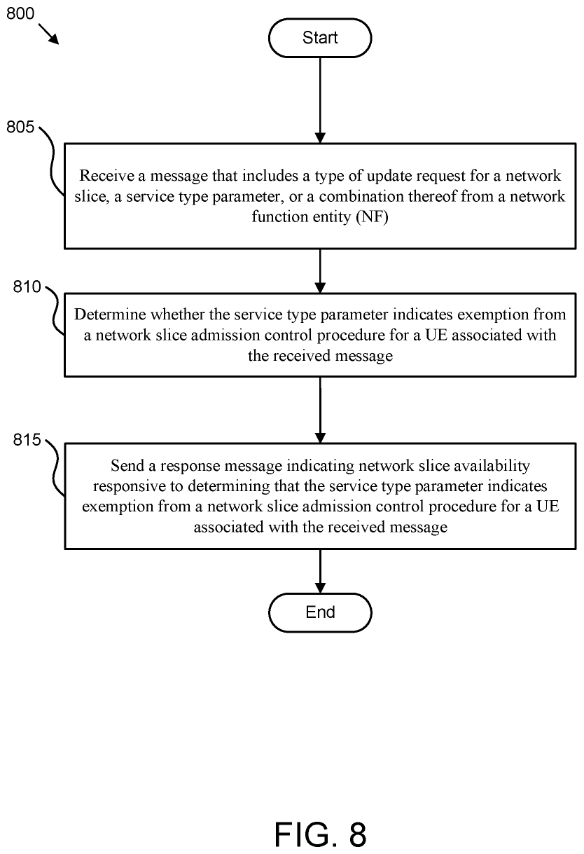

Referring to FIG. 8, a flow diagram of a method 800 performed at a NSACF entity. At a block 805, a message is received that includes a type of update request for a network slice, a service type parameter, or a combination thereof from a network function entity. At a block 810, determining whether the service type parameter indicates exemption from a network slice admission control procedure for a UE associated with the received message is performed. At a block 815, a response message is sent that indicates network slice availability responsive to determining that the service type parameter indicates exemption from a network slice admission control procedure for a UE associated with the received message.

A. A method at a network function (“NF”) entity, the method comprising: receiving, from a user equipment (“UE”), a first message requesting to register with a network slice: determining a network slice update type parameter, a service type parameter, or both, based on UE registration data in the first message or subscription data; and transmitting, to a network slice admission control function entity (“NSACF”), a second message requesting to modify a number of UEs registered with the network slice, the second message comprising the network slice update type parameter, or the service type parameter, or both.

B. The method of A, wherein the network slice update type parameter comprises a value indicating a new registration or an existing registration.

C. The method of B, further comprising: in response to the network slice being part of an allowed network slice, determining that the network slice update type parameter corresponds to the existing registration: or in response to the network slice not being part of the allowed network slices, determining that the network slice update type parameter corresponds to the new registration.

D. The method of any of A-C, wherein the service type parameter indicates an emergency service, a multimedia priority service, or mission critical services, or a combination thereof, associated with the network slice.

E. An apparatus for wireless communication, the apparatus comprising: a processor; and a memory coupled with the processor, the processor configured to cause the apparatus to: receive, from a user equipment (“UE”), a first message requesting to register with a network slice: determine a network slice update type parameter, a service type parameter, or both based on UE registration data in the first message or subscription data; and transmit, to a network slice admission control function entity (“NSACF”), a second message requesting to modify the number of UEs registered with the network slice, the second message comprising the network slice update type parameter, the service type, or both.

F. The apparatus of E, wherein the network slice update type parameter comprises a value indicating a new registration or an existing registration.

G. The apparatus of F, wherein if the network slice is part of an allowed network slice, the processor is further configured to cause the apparatus to determine that the network slice update type parameter corresponds to the existing registration; or if the network slice is not part of the allowed network slices, the processor is further configured to cause the apparatus to determine that the network slice update type parameter corresponds to the new registration.

H. The apparatus of any of E-G, wherein the service type parameter indicates an emergency service, a multimedia priority service, mission critical services, or a combination thereof associated with the network slice.

I. A method at a network slice admission control function (“NSACF”) entity, the method comprising: receiving, from a network function entity (“NF”), a request message indicating to modify a number of user equipments (“UEs”) registered with a network slice, wherein the request message includes a slice update type parameter for the network slice, a service type parameter, or both: determining whether to accept or reject a registration of the network slice based on the number of UEs registered with the network slice satisfying a threshold number of UEs and the network slice update type parameter, the service type parameter, or both; and transmitting a response message indicating an acceptance or a rejection of the network slice registration.

J. The method of I, wherein the network slice update type parameter comprises a value indicating a new registration or an existing registration.

K. The method of J, wherein determining whether to reject the registration of the network slice is further responsive to the network slice update type parameter indicating that the network slice is part of the new registration.

L. The method of J, wherein determining whether to accept the registration of the network slice is further responsive to the network slice update type parameter indicating that the network slice is part of the existing registration.

M. The method of any of I-L, wherein determining whether to accept the registration of the network slice is further responsive to the service type parameter indicating an emergency service, a priority service, or mission critical services, or a combination thereof, associated with the network slice.

N. An apparatus comprising: a processor; and a memory coupled with the processor, the processor configured to cause the apparatus to: receive, from a network function entity (“NF”), a request message indicating to modify a number of user equipments (“UEs”) registered with a network slice, wherein the request message includes a slice update type parameter for the network slice, a service type parameter, or both: determine whether to accept or a reject registration of the network slice based on the number of UEs registered with the network slice satisfying a threshold number of UEs and the network slice update type parameter, the service type parameter, or both; and transmitting a response message indicating an acceptance or a rejection of the network slice registration.

O. The apparatus of N, wherein: the network slice update type parameter has a value of a new registration or an existing registration: the processor determines whether to reject registration of the network slice is further responsive to the network slice update type parameter indicating that the network slice is part of a new registration: the processor determines whether to accept registration of the network slice is further responsive to the network slice update type parameter indicating that the network slice is part of an existing registration or the service type parameter indicating an emergency service, a priority service, or mission critical services which are to be used over the network slice.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of performing a network function (NF), the method comprising:
receiving, from a user equipment (UE), a first message requesting to register with a network slice;
determining a registered indication based on UE registration data in the first message or subscription data; and
transmitting, to a network slice admission control function entity (NSACF), a second message requesting to modify a number of UEs registered with the network slice, the second message comprising the registered indication.

2. The method of claim 1, wherein the registered indication comprises a value indicating a new registration or an existing registration.

3. The method of claim 2, further comprising:
in response to the network slice being part of an allowed network slice, determining that the registered indication corresponds to the existing registration; or
in response to the network slice not being part of the allowed network slices, determining that the registered indication corresponds to the new registration.

4. (canceled)

5. An apparatus for performing a network function (NF), the apparatus comprising:
at least one memory; and
at least one processor coupled with the at least one memory and configured to cause the apparatus to:
receive, from a user equipment (UE), a first message requesting to register with a network slice;
determine a registered indication based on UE registration data in the first message or subscription data; and
transmit, to a network slice admission control function entity (NSACF), a second message requesting to modify the number of UEs registered with the network slice, the second message comprising the registered indication.

6. The apparatus of claim 5, wherein the registered indication comprises a value indicating a new registration or an existing registration.

7. The apparatus of claim 6, wherein if the network slice is part of an allowed network slice, the at least one processor is configured to cause the apparatus to determine that the registered indication corresponds to the existing registration; or
if the network slice is not part of the allowed network slices, the at least one processor is configured to cause the apparatus to determine that the registered indication corresponds to the new registration.

8. (canceled)

9. A method of performing a network slice admission control function (NSACF), the method comprising:
receiving, from a network function (NF) entity, a request message indicating to modify a number of user equipments (UEs) registered with a network slice, wherein the request message includes a registered indication;
determining whether to accept or reject a registration of the network slice based on the number of UEs registered with the network slice satisfying a threshold number of UEs and the registered indication; and
transmitting a response message indicating an acceptance or a rejection of the network slice registration.

10. The method of claim 9, wherein the registered indication comprises a value indicating a new registration or an existing registration.

11. The method of claim 10, wherein determining whether to reject the registration of the network slice is further responsive to the registered indication indicating that the network slice is part of the new registration.

12. The method of claim 10, wherein determining whether to accept the registration of the network slice is further responsive to the registered indication indicating that the network slice is part of the existing registration.

13. (canceled)

14. An apparatus for performing a network slice admission control function (NSACF), the apparatus comprising:
at least one memory; and
at least one processor coupled with the at least one memory and configured to cause the apparatus to:
receive, from a network function (NF), a request message indicating to modify a number of user equipments (UEs) (“UE”) registered with a network slice, wherein the request message includes a registered indication;
determine whether to accept or a reject registration of the network slice based on the number of UEs registered with the network slice satisfying a threshold number of UEs and the registered indication; and
transmitting a response message indicating an acceptance or a rejection of the network slice registration.

15. The apparatus of claim 14, wherein:
the registered indication has a value of a new registration or an existing registration;
the at least one processor is configured to cause the apparatus to determine whether to reject registration of the network slice is further responsive to the registered indication indicating that the network slice is part of a new registration;
the at least one processor is configured to cause the apparatus to determine whether to accept registration of the network slice is further responsive to the registered indication indicating that the network slice is part of an existing registration.
